(19) United States
(12) Patent Application Publication
(10) Pub. No.: US 2016/0060884 A1
(43) Pub. Date: Mar. 3, 2016

(54) JOINT COMPOUND TOOL

(71) Applicant: United States Gypsum Company, Chicago, IL (US)

(72) Inventors: Nancy L Bernicke-Grussing, Trevor, WI (US); Joshua Sheldon, Vernon Hills, IL (US)

(21) Appl. No.: 14/476,426

(22) Filed: Sep. 3, 2014

(51) Int. Cl. E04F 21/165; B65D 25/10; B65D 43/00; B25H 3/00

(52) U.S. Cl. CPC E04F 21/1655; B25H 3/00; B65D 25/10; B65D 43/00

(57) ABSTRACT

A joint compound tool including a handle having a first end and a second end where a blade portion is attached to the first end and a mixing member is attached to the second end. The handle, the blade portion and the mixing member each have substantially the same thickness where the mixing member is used to mix joint compound and the blade is used to apply the joint compound to a surface.

### BACKGROUND

The present application relates generally to hand tools used in wall finishing, and more particularly to such tools used for mixing and applying joint compound.

Joint compound is available in various forms including a ready-mixed form that is pre-mixed and can be immediately applied to a surface and in a powder form that must be mixed with water prior to application. For larger quantities, the powder is mixed in a large container, such as a five gallon bucket, by hand or with a powered mixing tool. For smaller quantities, the powder is mixed in a relatively small container, such as a mud pan, that can be held with one hand and mixed with the other hand using a mixing stick, the blade of a spackle knife or the like. Because the edges of the blade could be scratched or damaged during mixing, it is preferable to use a separate mixing tool to mix the joint compound and use a spackle knife to apply it to a surface. Carrying multiple tools at a job site can be cumbersome and difficult, especially when working on a ladder or scaffolding. Also, tools are commonly lost or misplaced, so reducing the number of tools needed at a job site minimizes down time and enhances efficiency.

Accordingly, there is a need for a joint compound tool that performs multiple functions.

### SUMMARY

The present joint compound tool is a single tool having an end for mixing a quantity of joint compound and an opposing end for applying the mixed joint compound to a surface.

In an embodiment, a joint compound tool is provided that includes a handle having a first end and a second end where a blade portion is attached to the first end, and a mixing member is attached to the second end. The handle, the blade portion and the mixing member each have substantially the same thickness, where the mixing member is used to mix joint compound and the blade is used to apply the joint compound to a surface.

In another embodiment, a joint compound tool assembly is provided and includes a container having a bottom wall and a sidewall extending from the bottom wall, where the bottom wall defines a receptacle. A joint compound tool is configured to be inserted and secured in the receptacle. The tool includes a handle having a first end and a second end, a blade portion attached to the first end and a mixing member attached to the second end, where the handle, the blade portion and the mixing member each have substantially the same thickness such that when the tool is secured in the receptacle, a surface of the tool is substantially flush with the bottom wall of the container.

### BRIEF DESCRIPTION OF THE DRAWINGS

FIG. 1 is a top view of the tool of the present disclosure;

FIG. 2 is a side view of the tool of FIG. 1; and

FIG. 3 is an end view of the tool of FIG. 1 as viewed from the end including the mixing member.

FIG. 4 is a side view of an embodiment of a mixing container including a recessed area for storing the tool of FIG. 1; and

FIG. 5 is a bottom view of the mixing container of FIG. 4 including the tool of FIG. 1.

### DETAILED DESCRIPTION

The present tool is a single tool with multiple blades that is configured for enabling a user to both mix a quantity of joint compound and apply the mixed joint compound to a surface. Thus, the user saves time and costs by reducing the number of separate tools that need to be brought to, carried and used at a job site.

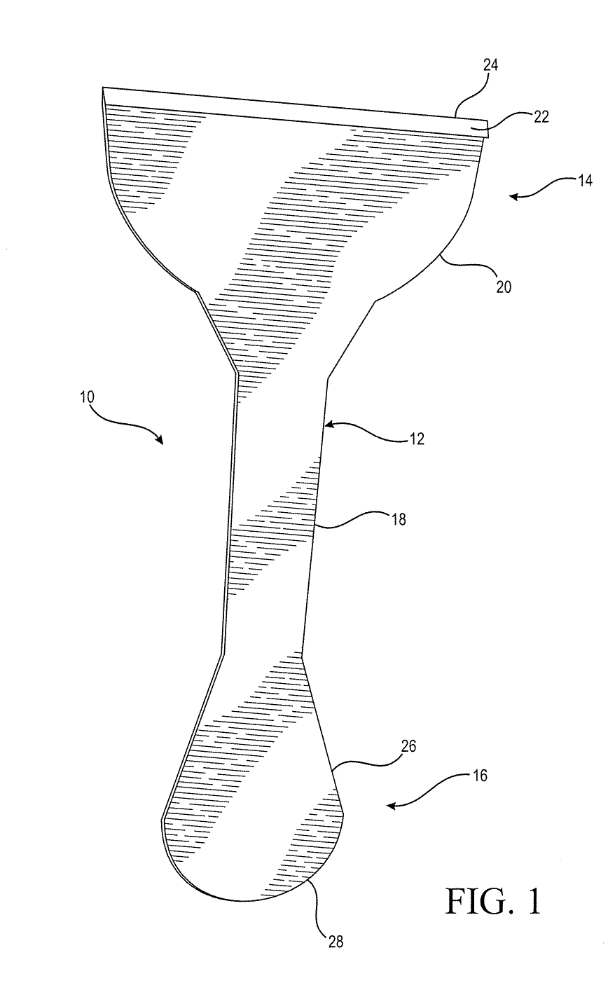

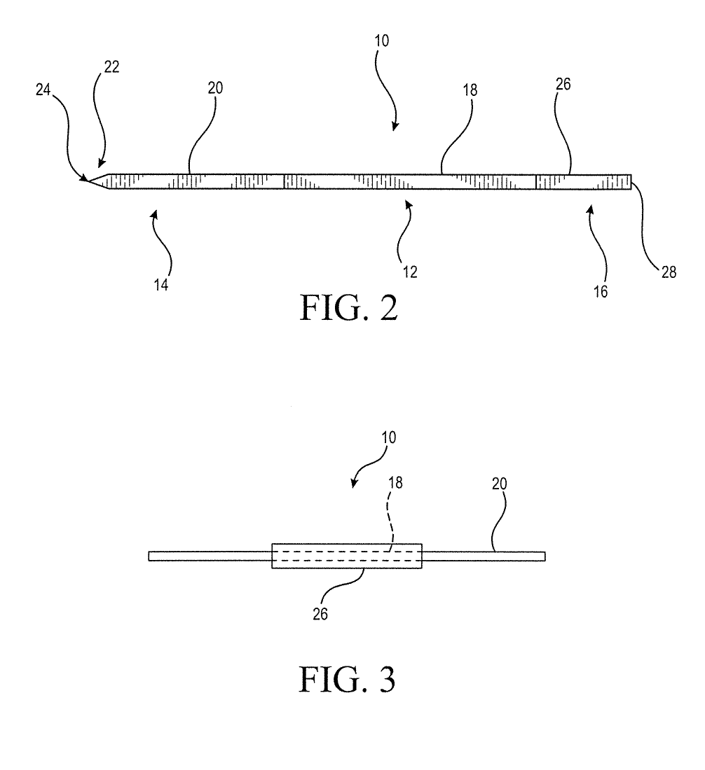

Referring now to FIGS. 1-3, the tool generally designated as reference number 10 includes a generally flat body 12 having a first end 14, a remote and preferably opposing second end 16, and a handle 18 between the first end and the second end. The first end 14 is wider than the handle 18 and includes a blade portion 20 integrally formed with the handle. A blade 22 is attached to the blade portion 20 and has a pointed edge 24 configured for applying joint compound to a surface or surfaces. The body 12 may be made with a single material, such as a durable plastic, where the pointed edge is formed in or molded on the blade portion. The blade 22 may also be attached to the blade portion 20 and made with the same material or a different material than the blade portion. For example, the blade portion 20 may be made with plastic and the blade 22 made with a metal such as stainless steel.

The handle 18 extends from the blade portion 20 and has a sufficient length to be easily gripped by a user's hand. In an embodiment, the handle 18 has a width of 1.0 to 1.5 inches and a length of 4.0 to 4.5 inches. It should be appreciated that the width and length of the handle 18 may be any suitable width and length. The flat profile of the handle 18 enables the handle to be easily gripped by a user and stored in a tool container, the user's pocket or other suitable container.

A mixing member 26 extends from the handle 18 at the second end 16 of the body 12. In this application, “end” is contemplated as being broadly defined, in that the blade 22 and the mixing member 26 are potentially positioned on one end and one side of the body 12, and are not necessarily diametrically opposite each other. The mixing member 26 tapers outwardly from the handle 18 and has a curved or rounded peripheral edge 28. The curved edge 28 of the mixing member 26 enables the mixing member to be easily moved along curved surfaces or into corners of containers to thoroughly mix joint compound in the containers. While any width is contemplated, the mixing member 26 preferably has a width of 3.0-3.5 inches. Furthermore, in an embodiment, the mixing member 26 has a curved or cup-shaped configuration to be able to scoop and mix the joint compound thereby further enhancing the ability of the tool 10 to mix joint compound.

Typically at a job site, joint compound is mixed in a container using a mixing tool or the blade or handle of a mud knife. Thus, multiple tools are required at a job site to mix and apply the joint compound which is burdensome and time consuming. Alternatively, using the blade of a mud knife to mix the joint compound could damage the blade or leave residue on the blade making it difficult to smoothly apply the mixed joint compound to a surface. Similarly, using the handle of the mud knife may leave residue on the handle which will make the handle slippery and difficult to grip.

The present tool 10 is a single tool that overcomes the above issues. In use, the mixing end and mixing member 26 of the tool is inserted into a container including joint compound powder and water and moved around in the container to mix the joint compound. The flat profile of the mixing member 26 enables the joint compound to be easily and smoothly mixed in the container. Also, since the mixing member 26 is spaced from the handle 18, less of the mixed joint compound gets on the handle enabling a user to firmly grip the handle during use.

After mixing the joint compound, the mixed joint compound is applied to a surface, such as a wall, with the blade 22 and spread onto the surface. Similar to the mixing member 26, the blade is spaced from the handle 18 such that the mixed joint compound is less likely to get on the handle during use. The blade 22 has the narrowed or pointed edge 24 for facilitating smooth spreading by a user of the mixed joint compound on the surface.

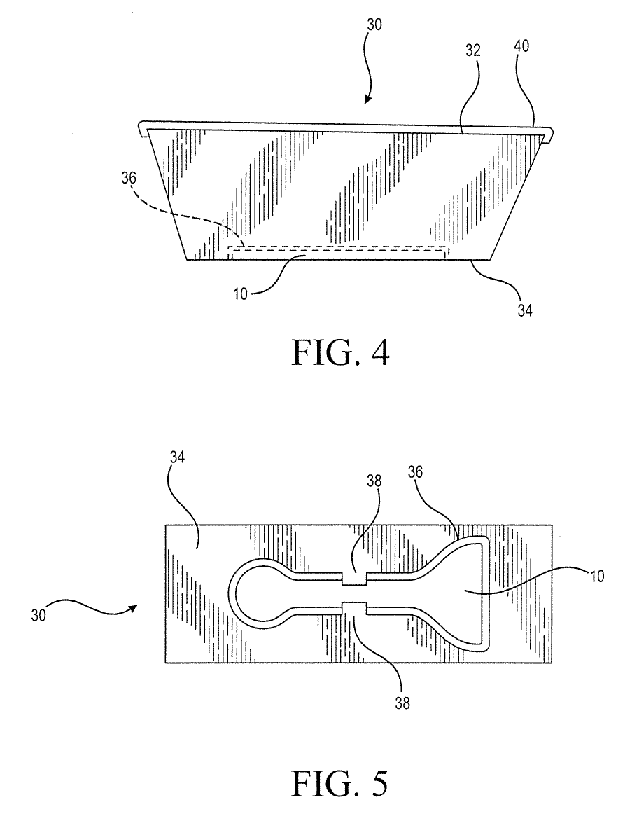

Referring now to FIGS. 4 and 5, an embodiment is illustrated that includes a container 30 having any suitable shape and size, where the container has an open top end 32 and a bottom end or bottom wall 34. The bottom wall 34 includes a recessed area or receptacle 36 that has a shape that is generally the same as the shape of the tool 10 in FIGS. 1-3. It should be appreciated that the shape and size of the receptacle 36 may be any suitable size and shape. The receptacle 36 has a depth that is generally the same as the thickness of the tool 10 such that the tool is flush with the bottom wall 34 when the tool is inserted in the receptacle. At least one securing arm, and preferably a pair of securing arms 38, is integrally formed with the bottom wall 34 and extends at least partially into the receptacle 36. The securing arms 38 extend at least partially over a portion of the tool 10 located in the receptacle 36 to secure the tool in the receptacle when the tool is not being used. It should be appreciated that the bottom wall 34 may include one, two or more securing arms 38 for securely holding the tool 10 in the receptacle 36. Also, the receptacle 36 is optionally located on an upper surface of the bottom wall 34.

In use, the tool 10 is removed from the receptacle 36 on the bottom wall 34 of the container 30. Pre-mixed joint compound or joint compound powder and water is added to the container 30 and the mixing member 26 of the tool is used to mix the joint compound in the container as described above. In an embodiment, a lid 40 (FIG. 4) may be attached to the sidewall and cover the open end of the container 30 to seal the container for temporary storage of the mixed joint compound or transport to another location. The mixed joint compound is then applied and spread on a surface using the blade 22 of the tool 10. After the joint compound is sufficiently spread on the surface, the tool 10 is reinserted into the receptacle 36 and secured in place by the securing arms 38 for transporting the tool 10 and the container 30 to another job location or job site. Thus, the combination of the container 30 and the tool 10 allows for easy and quick transport of the container and tool and minimizes the burden on the user as only one item needs to be stored and/or carried on a job site instead of multiple tools and containers.

While particular embodiments of the present joint compound tool and methods of using the tool have been shown and described, it will be appreciated by those skilled in the art that changes and modifications may be made thereto without departing from the invention in its broader aspects and as set forth in the following claims.

What is claimed is:

1. A joint compound tool comprising:
a handle having a first end and a second end;
a blade portion attached to said first end; and
a mixing member attached to said second end,
wherein said handle, said blade portion and said mixing member each have substantially the same thickness, and
wherein the mixing member is used to mix joint compound and the blade is used to apply the joint compound to a surface.

2. The tool of claim 1, wherein said mixing member and said handle each have a width, said width of said mixing member being greater than said width of said handle.

3. The tool of claim 1, wherein at least a portion of a peripheral surface of said mixing member is curved.

4. The tool of claim 1, wherein said blade portion includes a blade.

5. The tool of claim 4, wherein said blade is made of a first material and said handle and said mixing member are made of a second material, wherein said first material is different from said second material.

6. The tool of claim 1, wherein said blade portion and said mixing member are integrally formed with said handle.

7. The tool of claim 1, wherein said blade portion and said mixing member each have a width that is greater than a width of said handle.

8. A joint compound tool assembly comprising:
a container having a bottom wall and a sidewall extending from said bottom wall, said bottom wall defining a receptacle; and
a joint compound tool configured to be inserted and secured in said receptacle, said tool including a handle having a first end and a second end, a blade portion attached to said first end and a mixing member attached to said second end, wherein said handle, said blade portion and said mixing member each have substantially the same thickness such that when the tool is secured in said receptacle, a surface of the tool is substantially flush with the bottom wall of the container.

9. The assembly of claim 8, wherein said bottom wall includes at least one securing arm that extends at least partially over the tool when the tool is inserted in said receptacle to secure the tool in said receptacle.

10. The assembly of claim 8, further comprising a lid secured to said sidewall for sealing an open end of said container.
